(19) United States
(12) Patent Application Publication
(10) Pub. No.: US 2019/0142557 A1
(43) Pub. Date: May 16, 2019

(54) Applications, Uses, Methods of Moldable Material for Dental Uses

(71) Applicant: Bradley Bartelli, Corpus Christi, TX (US)

(72) Inventor: Bradley Bartelli, Corpus Christi, TX (US)

(21) Appl. No.: 15/810,010

(22) Filed: Nov. 11, 2017

(51) Int. Cl. A61C 13/08; A61C 13/107; A61C 13/00; A61C 5/30; A44C 15/00; A63J 7/00

(52) U.S. Cl. CPC A61C 13/082; A61C 13/0001; A61C 13/0006; A61C 2201/007; A44C 15/007; A63J 7/005; A61C 5/30

(57) ABSTRACT

This disclosure generally relates to people who do not have the time or money to go to a dentist right away or they are phobic. People need an affordable and easy solution to this problem that they can manage themselves until they can get professional dentist help. If a tooth or dental restoration goes missing the adjacent and opposing teeth can shift causing more harm; this invention can help to hold and stabilize the teeth and help prevent further shifting and harm. This invention could help improve someone's speech, smile, and self-confidence. This invention can be a solution for temporary tooth replacement while an extraction site, implant site, or surgery site is healing. This invention could be used by professionals and non-professionals in the home, office, or on the go traveling. This invention could be good to have with first-aid kits at home, office, or schools. Additional dental uses are also possible.

### FIELD OF THE INVENTION

### Field of the Invention

The present invention generally relates to a method for creating a temporary tooth. More specifically, the present invention introduces a method that allows users to form a temporary tooth with their fingers using a moldable material and household tools. This moldable material can be a thermoplastic material such as PCL.

### Background

The present invention relates to teeth replacement and it allows people an easy and affordable temporary solution to temporary tooth construction of the replacement of teeth and dental restorations along with other dental uses. Currently, many people have missing teeth due to a number of different causes. The most common of these causes include tooth decay, periodontal disease, and trauma causing the tooth or teeth to be dislodged from the user's gums. Other causes that induce missing teeth include genetic defects and diseases. A number of problems can arise for a person with missing teeth, With missing teeth, the person's ability to chew is significantly decreased and foods are likely to lodge into the spaces where a tooth or teeth are missing. Lodging of food particles into the open spaces can induce bacteria growth, which can cause infection to a person's gums.

Missing teeth can also impede a person's ability to properly speak and pronounce different words. Words containing sibilants or fricatives are difficult words for people with missing teeth to pronounce. This problem can often lead to miscommunication and frustration, Another problem for people with missing teeth is “drifting”. Due to the exorbitant cost of most permanent tooth replacement many individuals having limited or fixed incomes and/or not being covered by comprehensive dental insurance have sought out stop-gap or temporary tooth constructions that will not only maintain their usual physical appearance but will also serve for at least a reasonable period of time as an adequate replacement for the more costly permanent solution to the problem. As a consequence of the foregoing situation, there has existed a long standing need among many individuals for a low cost, yet simple, efficient, and aesthetically pleasing temporary tooth construction that will serve for a limited time basis as an adequate substitute for a more permanent tooth replacement. Those concerned with these and other problems recognize the need for an improved temporary tooth construction.

People need an affordable and easy solution for this problem that they can manage themselves until they can get professional dentist help. If a tooth or dental restoration goes missing the adjacent and opposing teeth can shift causing more harm; this invention can help to hold and stabilize the teeth and help prevent further shifting and harm. This invention could help improve someone's speech, smile, and self-confidence. This invention can be a solution for temporary tooth replacement while an extraction site, implant site, or surgery site is healing. This invention could be used by professionals and non-professionals in the home, office, or on the go traveling. This invention could be good to have with first-aid kits at home, office, or schools. Additional dental uses are also possible.

### DETAILED DESCRIPTION OF THE RELATED ART

The present invention discloses a temporary tooth construction that forms the basis of the present invention. The invention comprises a tooth unit designed. Dimensioned and configured to present the external appearance of one or more of a user's teeth. The present invention is a method for forming a temporary tooth using a moldable, thermoplastic, non-toxic and biodegradable material. The materials required for the method of the present invention include a plurality of plastic material like PCL, a volume of liquid, a container, a heating means. A thermoplastic material such as PCL can be such a material as PCL can be heated to become soft and moldable. Methods to heat can be in a hot liquid like water, direct heat source, directly from microwave or others. There are various methods to use such material to form a tooth, dental restoration or other dental uses.

For a missing tooth, like a front tooth for example: When a material such as PCL is soft, use fingers to form a ball wider than the missing tooth space. Press ball into empty space from the backside of teeth. Use other fingers to press from the front and top sides' level with other adjacent teeth to form the material into the space. Press excess material to the backsides of the adjacent teeth and gums to form “holding wings.” While still soft, bite into the material to conform to bite. While the material is firm to hold shape but still soft, remove from mouth. The shape can be defined outside or inside the mouth while still soft. The fit must be re-confirmed in the mouth. The shape can also be adjusted after material hardens with various tools or instruments. Fingers, dental tools, or other household tools can be used for the process. PCL material will harden when it cools but can be reheated to further adjust form or to completely start over. The material can be colored in various ways to match or blend in with the other teeth or to the gingiva. The material can be colored or dyed while the material is soft or after the material has hardened

Temporary dental crown method: a similar method to the previous, however, the ball of material is better inserted more from the incisal to the gingival direction to press the ball over the existing prepped tooth stump. Also, it is likely less material will be needed than to replace an entire tooth.

Temporary dental bridge method: a similar method to the previous but for a 3 unit bridge as an example, more material will be needed and instead of one ball, three connected balls or a cylinder or hotdog shape that is slightly longer than space can be used. This may also be better inserted and pressed into the prepped teeth stumps and empty space from more of an incisal to gingival direction. In each case, no matter what teeth or how many teeth; the “holding flaps” can be formed to help with retention.

The “holding flaps” can also be formed on the front sides of the adjacent teeth and/or gums, separate to or in addition to on the backsides if needed for further retention. Although placing the “holding flaps” in a more visible place may not be as cosmetic. “Holding flaps” can be of any size as needed. They may be small and not really visible, only at the spot of touching the adjacent teeth or larger flap covering more of the adjacent teeth and gums area. They may be continuously connected to each other looking like one big flap or separate flaps.

Another method for replacing a tooth can use a two-part method, with one part being a gingival color and the other part being a tooth color. This method can be useful for certain situations, such as where there is a gingival defect or more bone resorption and without the addition of a gingival colored portion to the replacement all tooth colored replacement would look like one very large tooth. This method can be used similar to the previous methods but in a two-colored part more like a removable partial denture method where a denture base is formed that covers more of the gingival tissues. In these, the first gingival part is molded to the gingival tissue of the desired area and also can be part of the backside of teeth. In the missing tooth space a rough area and with indentations, a pocket, and/or protrusions are left that will allow the second tooth colored part to adhere to. This second tooth colored part can be performed similar to the other previous ball method, but less material will be needed.

To form a temporary bite guard, retainer, or tooth splinting device: the material is formed into a hotdog shape and to the length of teeth area you wish to cover. The hotdog material shape is curved to the same shape of your dental arch and then pressed over the incisal edges and to the desired position and thickness. All various shapes and thicknesses can be achieved depending on the use and situation.

All of these methods can be colored or shaped to the “traditional” and “natural” colors and shapes or they may be made “non-traditional or not natural” colors or shapes. Other items or materials may be added or inserted into the materials also. Example: someone may wish to have a red tooth in a larger vampire fang shape with a gem inserted on the front. These methods may be used for “normal” or “costume play” uses. This is not meant to be a substitute for professional medical/dental services and people should still seek professional medical/dental consultation and help when possible.

Although the invention has been explained in relation to its preferred embodiment, it is to be understood that many other possible modifications and variations can be made without departing from the spirit and scope of the invention as hereinafter claimed

### SUMMARY

In light of the shortcomings of the prior art, the following summary is provided to facilitate an understanding of some of the innovative features unique to the present invention and is not intended to be a full description. A full appreciation of the various aspects of the invention can be gained by taking the entire specification, claims, drawings, and abstract: as a whole.

The primary objective of this invention is to help improve someone's speech, smile, and self-confidence. This invention can be a solution for temporary tooth replacement while an extraction site, implant site, or surgery site is healing. This invention could be used by professionals and non-professionals in the home, office, or on the go traveling. This invention could be good to have with first-aid kits at home, office, or schools. Additional dental uses are also possible.

Another object of the invention relates to missing teeth, the person's ability to chew is significantly decreased, and foods are likely to lodge into the spaces where a tooth or teeth are missing. Lodging of food particles into the open spaces can induce bacteria growth which can cause infection to a person's gums. Missing teeth can also impede a person's ability to properly speak and pronounce different words. Words containing sibilants or fricatives are difficult words for people with missing teeth to pronounce. Sibilants are words that require the use of directing a jet of air through a narrow channel in the vocal tract towards the sharp edge of the teeth. Another problem for people with missing teeth is “drifting.” This is when the teeth on each side of a missing tooth start to “drift” towards the empty space created by the missing tooth.

This Summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of the missing teeth

FIG. 2 shows the plurality of ball of material placed behind teeth, ball wider than space

FIGS. 3 and 4 shows a plurality of “Holding wings” being formed

FIG. 4 shows a plurality of “Holding wings” on the finished and removed the temporary tooth.

FIG. 5 shows tooth being molded in empty space and “holding wings” formed on the back of teeth and gums represented by the dashed lines.

FIG. 6 shows the completed tooth with “holding wings” and a restored smile, teeth completed. As FIG. 6 is a diagram of the completed hardened tooth replacing the missing tooth.

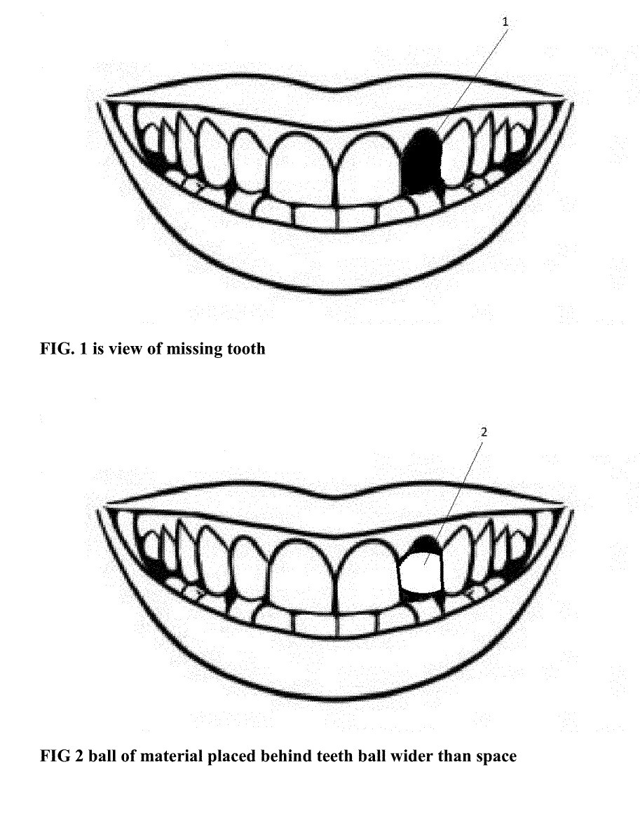

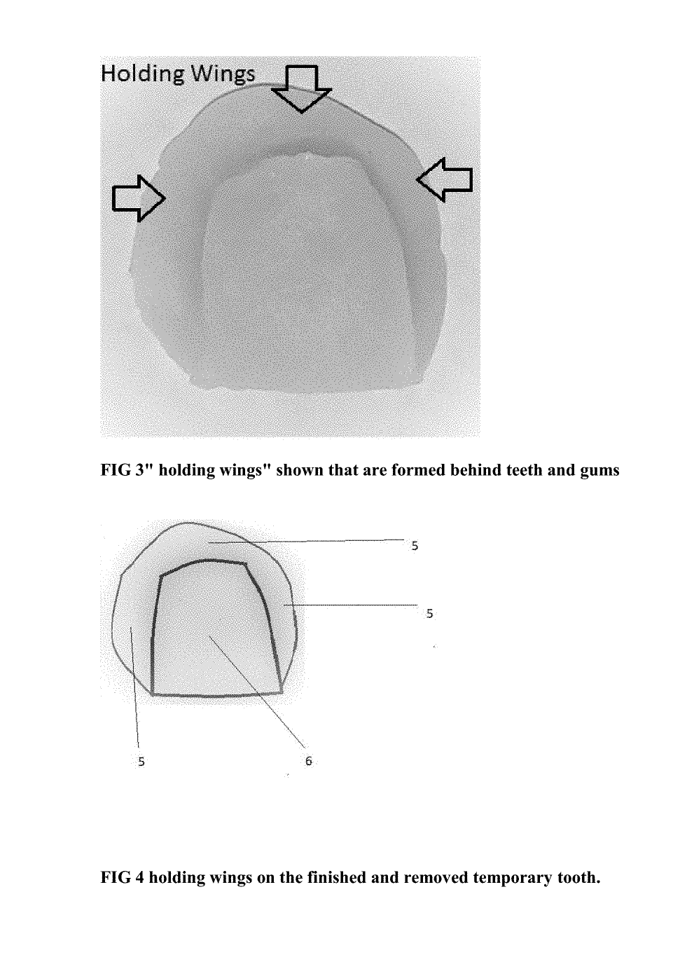

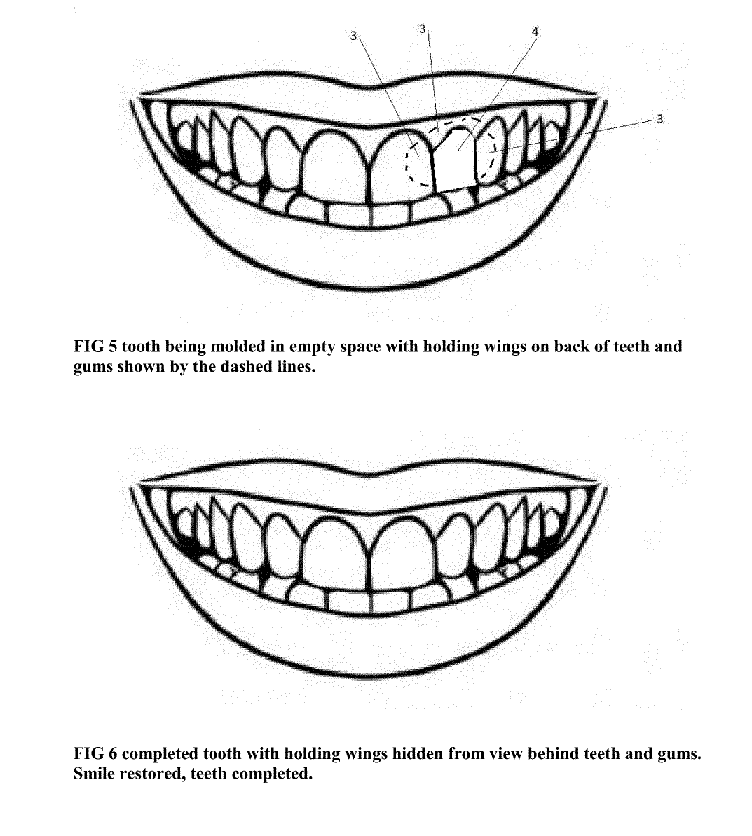

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of creating a temporary tooth comprises
Remove desired amount of Tooth material pellets and place into empty ladle spoon Top front tooth=about 25 pellets, Bottom front tooth=about 20 pellets; Larger tooth and space=use more pellets. You can add pellets later or remove material as needed. A temporary crown will require less material and a temporary 3 unit bridge will require more.
Color tooth material to blend with your teeth: If your teeth are bleached white, skip the colorant part and continue with clear water below.
Fill the container to the line with water; microwave 1:30-2:00 minutes to get hot but not boiling.
Place Colorant bag into the water until water is dark, remove colorant bag and reheat water for 30 seconds-1:00 minute. Hot not boiling.
Carefully fill ladle spoon with hot water by dipping into a container and remove, letting pellets heat and start turning soft and clear. (If water is too hot, pellets will get too soft and start sticking)
When all pellets are clear, drain water and knead the pellets into one round ball with fingers that will be wider than the tooth space
Press softball of material into missing tooth space from the back side of your teeth and forward into the empty space. Use other fingers to cover and press from the front and top level with the other adjacent teeth. Allow and press excess material to push against the backside of your adjacent teeth and back of the gums. This will create “holding wings” for your temporary tooth.
Continue to sculpt to the desired shape.
Bite together while the material is soft to form your bite.
When material starts to cool down it will get more firm and start to turn back white and opaque.
Remove tooth while firming and able to hold the shape but still soft.
Refine the shape as you desire and replace to confirm and shape; press “holding flaps” against the back of teeth and gum area.

2. The kit includes moldable material that you can sculpt into a realistic tooth in minutes

3. This invention can be a solution for temporary tooth replacement while an extraction site, implant site, or surgery site is healing.

4. This method can be useful for certain situations, such as where there is a gingival defect or more bone restoration and without the addition of a gingival colored portion to the replacement the all tooth colored replacement would look like one very large tooth

5. Someone may wish to have a red tooth in a larger vampire fang shape with a gem inserted on the front. These methods may be used for “normal” or “costume play” uses. This is not meant to be a substitute for professional medical/dental services and people should still seek professional medical/dental consultation and help when possible.
